(19) United States
(12) Patent Application Publication
(10) Pub. No.: US 2026/0061941 A1
(43) Pub. Date: Mar. 5, 2026

(54) ENHANCED ENGINE COMPONENT COVERS AND TOOL ORGANIZATION SYSTEMS

(71) Applicant: Victor Belanich, San Diego, CA (US)

(72) Inventor: Victor Belanich, San Diego, CA (US)

(21) Appl. No.: 19/315,458

(22) Filed: Aug. 29, 2025

Related U.S. Application Data
(60) Provisional application No. 63/689,223, filed on Aug. 30, 2024.
(60) Provisional application No. 63/871,431, filed on Aug. 27, 2025.

(51) Int. Cl. B60R 7/08; B25H 5/00; B65D 1/36; B65D 25/20; F21V 33/00

(52) U.S. Cl. CPC B60R 7/08; B25H 5/00; B65D 1/36; B65D 25/20; F21V 33/0084

(57) ABSTRACT

This disclosure describes systems, methods, and devices for covering an engine component. The device comprises a main body having a top surface, with the main body configured to be removably installed over an engine component to shield it from debris. Around the periphery of the main body, a plurality of compartments are arranged, each dimensioned to retain various components. At least one accessory compartment is incorporated for organizing and storing small parts such as bolts, nuts, and washers. Additionally, a central element is integrated on the top surface of the main body, designed to receive a securing stud and capable of being modified to accommodate studs of varying diameters. The abstract is provided for informative purposes only and does not limit the scope of this disclosure.

### CROSS-REFERENCE TO RELATED APPLICATIONS

This application claims the benefit of U.S. Provisional Application No. 63/871,431, filed Aug. 27, 2025, and to U.S. Provisional Application No. 63/689,223, filed Aug. 30, 2024, the disclosures of which are incorporated herein by reference as if set forth in full.

### BACKGROUND

In the field of automotive repair and maintenance, there is an ongoing need for improved solutions that facilitate access to engine components while providing effective protection against contamination. During routine procedures, particularly those requiring the removal of protective covers or assemblies to reach underlying engine parts, it is common for sensitive components to be left exposed. This exposure can render internal engine parts vulnerable to contamination from foreign matter such as dirt, dust, fasteners, and hand tools. The inadvertent introduction of such materials into the engine may lead to significant mechanical issues, performance degradation, or, in severe cases, complete engine failure.

Current methods and tools for protecting engine components during maintenance often compromise either on protection, organization, or overall convenience, especially in confined workspaces. There remains a need for enhanced systems that not only shield engine elements from contaminants but also offer improved organization for tools and parts, thereby streamlining procedures and reducing the risk of accidental damage or loss. The features and solutions described herein, whether individually or in combination, are not known or disclosed in the prior art as of the filing date.

### BRIEF DESCRIPTION OF THE DRAWINGS

FIG. 1 depicts a top plan view of an engine component cover, illustrating the layout of the tool and parts tray with integrated spark plug holders, in accordance with one or more example embodiments of the present disclosure.

FIG. 2 depicts an engine component cover in use, in accordance with one or more example embodiments of the present disclosure.

FIG. 3 depicts an exploded perspective view of the engine component cover, in accordance with one or more example embodiments of the present disclosure.

FIG. 4 depicts a perspective view of the engine component cover, in accordance with one or more example embodiments of the present disclosure.

FIG. 5 depicts an engine component cover showing the remaining part of the dome, in accordance with one or more example embodiments of the present disclosure.

FIG. 6 illustrates a flow of illustrative process for an engine component cover system, in accordance with one or more example embodiments of the present disclosure.

It is understood that the above descriptions are for the purposes of illustration and are not meant to be limiting.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them.

In conventional automotive maintenance procedures, particularly those involving classic vehicles equipped with carbureted engines, it is standard practice to remove the air filter assembly to facilitate access to the carburetor and related engine components. However, this necessary step results in the carburetor being left exposed, thereby rendering the internal engine components highly susceptible to contamination by foreign matter, including, but not limited to, dirt, dust, fasteners, and hand tools. The inadvertent introduction of such contaminants into the carburetor can precipitate significant mechanical failures, engine performance degradation, or, in severe cases, complete engine malfunction.

The challenges presented by limited workspace within engine bays are further compounded for technicians and home mechanics alike, who must manage a multitude of small, precise components, such as carburetor jets, washers, and spark plugs, while simultaneously ensuring they do not misplace or drop these critical parts. Existing tool trays and protective covers found in the market are often lacking in key respects: they may be overly bulky, thereby impeding efficient workflow; their cost may be prohibitive for the average user; or they may simply fail to provide features that enhance safety and operational precision. For instance, the absence of self-centering receptacles for spark plugs in many commercial solutions can result in improper storage and increased risk of part loss or mix-up during maintenance or repair operations.

Additionally, many currently available trays or covers do not incorporate a raised perimeter or lip structure that would function to further shield the carburetor opening when the tray is being removed or adjusted, thereby leaving the carburetor momentarily unprotected and vulnerable to contamination. Some designs require the removal of the air cleaner stud, a step that can be inconvenient and time-consuming, especially in situations demanding frequent access or rapid tool switching. Furthermore, existing solutions are frequently incompatible with the closure of the vehicle's hood while installed, creating logistical obstacles for both mobile and stationary repair environments where it is preferable to secure the vehicle during breaks in service or to protect the engine from environmental exposure.

Accordingly, there exists a distinct and long-felt need for an engine component cover that overcomes the deficiencies of prior art by providing a compact, integratable, and ergonomic solution. Such a device should be capable of securely organizing a variety of tools and engine parts, including, but not limited to, spark plugs of multiple sizes, while simultaneously protecting the carburetor from unwanted debris ingress throughout the duration of maintenance and repair procedures. The ideal implementation would further accommodate continued closure of the vehicle's hood during use, support rapid installation and removal without extraneous disassembly steps, and include features such as dedicated, self-centering spark plug recesses and a raised protective lip or dome to maximize both utility and engine safety. This disclosure, as described herein, provides one or more embodiments addressing the technical and practical shortcomings of existing devices in the field of automotive maintenance.

Example embodiments of the present disclosure relate to systems, methods, and devices for an enhanced engine component cover.

According to various embodiments described herein, the disclosed engine component cover offers a versatile and modular solution for enhancing protection and organization in automotive environments. The design features a main body that can be removably installed over engine components, effectively shielding critical parts from debris and contamination. A series of integrally formed or attachable compartments are arranged around the main body, each specifically sized to retain hardware, tools, or engine accessories, thereby minimizing the risk of misplaced parts during maintenance. Additionally, the central region of the cover provides a customizable element with predetermined breakaway sections, allowing tool-free adjustment to fit a range of securing stud diameters. This configuration not only streamlines maintenance procedures but also ensures compatibility with different engine setups, making it well suited for both professional and consumer automotive use.

In one or more embodiments, the enhanced engine component cover addresses the challenges through a multifunctional design that is not only compact but also highly adaptable to a range of automotive maintenance scenarios. In one or more embodiments, the engine component cover may be engineered to securely hold up to 16 spark plugs of various sizes, and its dual-purpose tray transforms limited engine bay space into a well-organized workspace. The top tray is, in one or more embodiments, thoughtfully divided into functional sections, allowing for meticulous organization of tools and parts. An ergonomic radial inside edge, in one or more embodiments, allows users to easily pick up small items such as carburetor jets, springs, or washers, minimizing fumbling and improving workflow efficiency. Although spark plugs can be securely organized, the versatile compartments can also accommodate screwdrivers, bolts, nuts, and a variety of other essential tools and components, further enhancing the utility of the cover during maintenance procedures.

It should be noted that the compartment arrangements, including rings and accessory compartments described above, are provided solely by way of example. Other configurations, shapes, and organizational layouts may be envisioned without departing from the scope of the disclosure. Designers and users may tailor the number, form, and placement of compartments to suit particular needs, vehicle platforms, or maintenance practices, ensuring that the enhanced engine component cover remains universally adaptable and highly functional across a broad spectrum of applications.

In one or more embodiments, the enhanced engine component cover provides a protective central element (central dome) that integrates seamlessly with the tray. This central dome may accommodate a 5/16″ stud by default but is designed with intelligent breakaway features to also fit ¼″ studs or be optionally drilled to larger sizes should the user require. This ensures the carburetor, or any engine opening it covers, remains shielded from accidental debris, even during installation or removal, because the element (dome), in one or more embodiments, effectively blocks the entry of foreign objects, regardless of the stud configuration in use.

In one or more embodiments, the compact footprint of the device allows for the closure of a vehicle's hood while the tool remains installed, addressing a significant shortcoming of many existing solutions on the market. The main body is, in one or more embodiments, surrounded by a minimum of six compartments (referred to also as rings throughout this disclosure), each attached to the outside, which serve as dedicated holders for spark plugs or various small tools. These compartments can be circular, curved, square, or shaped in other geometries as required, providing enhanced versatility and organization. Each compartment is specifically dimensioned, in one or more embodiments, to self-center different spark plug sizes, enhancing organization and reducing the risk of part loss.

Furthermore, while some embodiments are described with a standard 5-inch (127 mm) diameter to accommodate the most common carburetor openings, the design is inherently modular. It can, in one or more embodiments, be readily modified to fit other prevalent sizes such as 2⅝″, 5⅛″, and 7 5/16″ diameters, ensuring compatibility with a diverse array of vehicle platforms and aftermarket modifications. This scalability of form factor allows serving not just as a specialized tool but as a universal solution adaptable to the needs of professional automotive shops, home garages, and mobile repair environments alike.

In one or more embodiments, the enhanced engine component cover also anticipates further enhancements. For example, magnetic strips can be incorporated to securely hold metal tools and parts, while flexible insets can accommodate a wider range of spark plug geometries. The addition of features such as detachable mini-LED lights for improved visibility in low-light engine bays, as well as customizable aesthetics further underscores the user-centric design philosophy behind this solution.

In one or more embodiments, the enhanced engine component cover may include not only the aforementioned compartments (e.g., rings), but also an array of thoughtfully designed accessory compartments situated adjacent to the rings. These additional compartments offer extra space to organize and securely store smaller items, such as carburetor jets, bolts, nuts, washers, or specialty fasteners that are frequently used during engine maintenance. By strategically positioning these compartments near the rings, the design ensures that users have immediate access to vital components without crowding the workspace or risking the loss of small parts within the engine bay.

The peripheral “rings” referenced throughout this disclosure may take on a variety of forms and nomenclature, serving as multifunctional organizational elements tailored to the needs of engine maintenance. These rings can be hollow in construction, spanning either a portion of the side wall of the engine component cover or extending fully from the top to the bottom of the engine component cover side wall. Depending on the particular embodiment, these structures can function as compartments, retainer loops, tool holsters, socket cradles, or organizer slots, among others. Whether circular, curved, or square, each design is intended to securely hold spark plugs, tools, fasteners, or other essential components, while maximizing accessibility and efficiency in the workspace. This flexibility in terminology and form highlights the cover's adaptability, allowing users and designers to select or redefine the compartment style best suited to their specific workflow or application.

This arrangement not only enhances efficiency but also streamlines the overall workflow. Mechanics and technicians can quickly sort, retrieve, and return various fasteners, minimizing downtime and reducing the likelihood of misplaced hardware. The thoughtful integration of both rings and adjacent compartments provides a comprehensive solution for organizing a diverse range of tools and parts, further distinguishing the cover as an indispensable asset for both professional and home garages alike.

In one or more embodiments, the enhanced engine component cover stands as a robust and highly adaptable solution, thoughtfully engineered to address persistent challenges encountered during automotive maintenance. By integrating advanced ergonomic features and a flexible design, it adeptly safeguards both traditional carburetor systems and modern EFI configurations. Its customizable diameter options ensure universal compatibility, while the incorporation of practical tray and dome elements significantly elevates both workspace safety and operational efficiency. Collectively, these advancements represent not only a substantial improvement over prior art but also a noteworthy leap forward in the evolution of automotive service accessories.

Moreover, the disclosed system distinguishes itself through its remarkable versatility. The number, arrangement, and size of the peripheral rings and accessory compartments can be tailored with case, allowing the device to seamlessly accommodate a diverse range of engine components. This adaptability extends beyond carburetors to encompass various air intake structures, valve covers, and related hardware found in automotive, marine, and even aviation settings. The modular configuration of the rings and compartments further enhances the device's longevity and relevance, as users can readily modify or replace specific elements to suit evolving engine designs or specialized maintenance requirements.

This thoughtful approach ensures that mechanics and technicians benefit from a workspace that is both orderly and secure, minimizing the risk of lost or misplaced parts while facilitating quick, intuitive access to essential tools and fasteners. Ultimately, the enhanced engine component cover emerges as an indispensable asset, equally valuable in professional repair shops, home garages, or mobile service environments, and capable of meeting the dynamic needs of today's automotive service industry.

The embodiments described above are presented by way of example, and it is understood that modifications, equivalents, and alternatives are within the scope of the disclosure. All combinations and subcombinations of the features disclosed herein are contemplated unless otherwise stated. Numerous other examples, configurations, processes, algorithms, etc., may exist, some of which are described in greater detail below. The present disclosure provides sufficient detail such that a person of ordinary skill in the art may practice the one or more embodiments of this disclosure without undue experimentation. Example embodiments will now be described with reference to the accompanying figures.

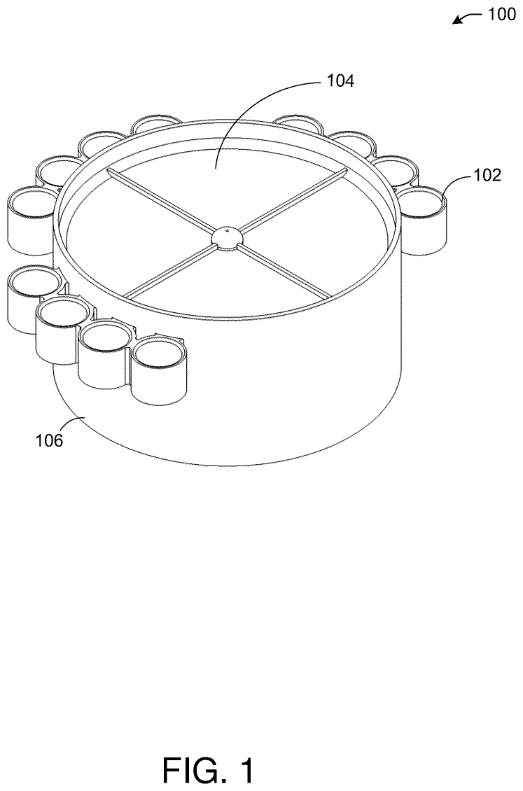

FIG. 1 depicts a top plan view of an engine component cover 100, illustrating the layout of the tool and parts tray with integrated tools and spark plug holders, in accordance with one or more example embodiments of the present disclosure.

When the engine component cover 100 is installed on top of an engine component (e.g., carburetor, or other equivalent components), it functions as a protective shield over the engine component, thereby preventing debris such as nuts, bolts, and even small hand tools from accidentally falling into it during engine maintenance or repairs. For instance, imagine a mechanic working under the hood, tools within arm's reach; a wrench slips from their grasp. With the cap installed, it simply lands on the cap, rather than plummeting into a carburetor's delicate internals.

The top 104 of the engine component cover 100 is ingeniously designed to double as a tool/parts tray, seamlessly transforming what would be wasted space into a highly functional work area. The tray is shown as top 104 in FIG. 1. This transformation is akin to having an extra pair of hands to hold tools such as screwdrivers, pliers, or the various nuts and bolts that are necessary for the task at hand, yet often cumbersome to manage in a crowded engine bay. The visual here is a busy mechanic efficiently laying out spark plugs in preformed insets specifically designed for them on the cap, next to orderly compartments holding carburetor jets and also a tray (e.g., tray 104) to place small items like bolts and nuts. These insets are compartments that may hold tools or spark plugs.

In one or more embodiments, the insets may be compartments (e.g., rings 102) attached to the outside of the body of the engine component cover 100. The compartment may serve as dedicated holders for spark plugs or various tools. Each compartments (referred to herein as rings) is specifically dimensioned to self-center different spark plug sizes, enhancing organization and reducing the risk of part loss. The rings may also be the mentioned in a way to hold the handle of a tool. This way a person could have access to a secure location to place spark plugs, tools, and other devices that may fit in these rings. The rings may be built-in the engine component cover 100 or they may be separately attached to the engine component cover 100. In FIG. 1, there is shown the vertical cylindrical surface 106 that may be the surface that the rings are molded with or attached to. These compartments (e.g., rings) can be circular, curved, square, or shaped in other geometries as required, providing enhanced versatility and organization. One or more of these compartments are specifically dimensioned, in one or more embodiments, to self-center different spark plug sizes, enhancing organization and reducing the risk of part loss.

Moreover, this tool holder can accommodate additional embodiments based on various automotive needs. For example, a magnetic strip could be seamlessly integrated along the outer edge of the tray's perimeter, strategically positioned to maximize access and securely hold metal tools and parts while keeping them within easy reach. Alternatively, the magnetic strip may be embedded within a designated compartment on the upper surface of the cover, providing a dedicated area for organizing metallic fasteners. Flexible insets (e.g., rings 102) might also be integrated, adapting to hold various spark plug sizes and shapes securely. The adaptability of this design could even extend to the inclusion of a detachable mini-LED light, ensuring visibility in the dimly lit under-hoods where mechanics commonly operate.

In one or more embodiments, the enhanced engine component cover is not strictly limited to carbureted engines; it is equally compatible with Electronic Fuel Injection (EFI) systems. This adaptability, in one or more embodiments, significantly broadens its utility, allowing mechanics and technicians to use the tray and protective features across a wide spectrum of engine types found in both classic and contemporary vehicles. Whether working on a traditional carburetor or a modern EFI throttle body, users benefit from the same organizational and protective advantages.

In one or more embodiments, the overall dimensions of the engine component cover 100 are carefully engineered to optimize compatibility with a broad range of carburetors. The current design features a 5-inch (127 mm) diameter, intentionally selected to fit the most common carburetor sizes found in today's engines. However, this diameter is not fixed; the engine component cover 100 can be readily modified to accommodate other prevalent sizes, such as 2-⅝″, 5⅛″, and 7 5/16″, ensuring adaptability across various automotive platforms. This attention to dimensional versatility, much like the compact circular profile of a standard 6-inch air cleaner, ensures the cover maintains a minimal footprint under the hood, suited for even the most confined engine compartments.

Not limited to functionality, the aesthetics of the tray could also be varied to suit personal preferences or to correlate with specific car brands or models, offering custom color schemes, or branding embossments for car enthusiasts who take pride in their workspace appearance as much as in their work.

In essence, the engine component cover 100 is not only a practical tool for maintaining the essential functioning of the vehicle but also a testament to the creative ingenuity embedded in developing automotive repair accessories. It represents a multi-faceted solution with the versatility to evolve with additional, innovative features that cater to a breadth of applications and user preferences.

Given its compact size, one of the engine component cover 100 standout features is the ability to allow the hood to close without any clearance issues. Imagine the convenience of leaving the cap on overnight during a multi-day project, thus maintaining continuous protection for the carburetor without having to disassemble and reassemble the setup each day.

Furthermore, this size advantage could branch into even more tailored applications. For example, with this space-saving design, additional tools or accessories could potentially be embedded within or attached to the cap's surface, similar to how a Swiss army knife houses multiple tools within a slim profile. Consider the possibility of integrating a small compartment for holding screws or clips, or a clasp mechanism that could attach a parts list or instructions directly onto the cap, ensuring all necessary information and materials are within reach yet never in the way.

The compact design of the carburetor cap not only offers functional efficiency but also could evolve to provide further innovation. It opens possibilities for integration with other vehicular systems, for instance, a thermal insulating material could be incorporated to shield the carburetor from engine heat, much like a heat shield, while still maintaining its petite stature.

In the world of automotive accessories, where space is at a premium and every inch counts, the engine component cover 100 compact size represents more than just a space-saving measure; it offers flexibility, durability, and the potential for multifunctional use, all while ensuring that the cap can be left in place with the hood securely closed, safeguarding the heart of the vehicle's powertrain.

The internal configuration of ring 102 is ingeniously designed with a cone-like, self-centering interior that accommodates a wide range of spark plug sizes, ensuring precise alignment much like a V-block in machining. Supporting everything from slender high-performance spark plugs to wider diesel variants, ring 102 maintains a maximum diameter to securely cradle even larger tools, similar to the universal grip of an adjustable wrench or drill chuck. This thoughtful design balances form and function, providing both secure placement for spark plugs and generous capacity for substantial tools such as large screwdrivers or torque wrenches.

It is understood that the above descriptions are for the purposes of illustration and are not meant to be limiting.

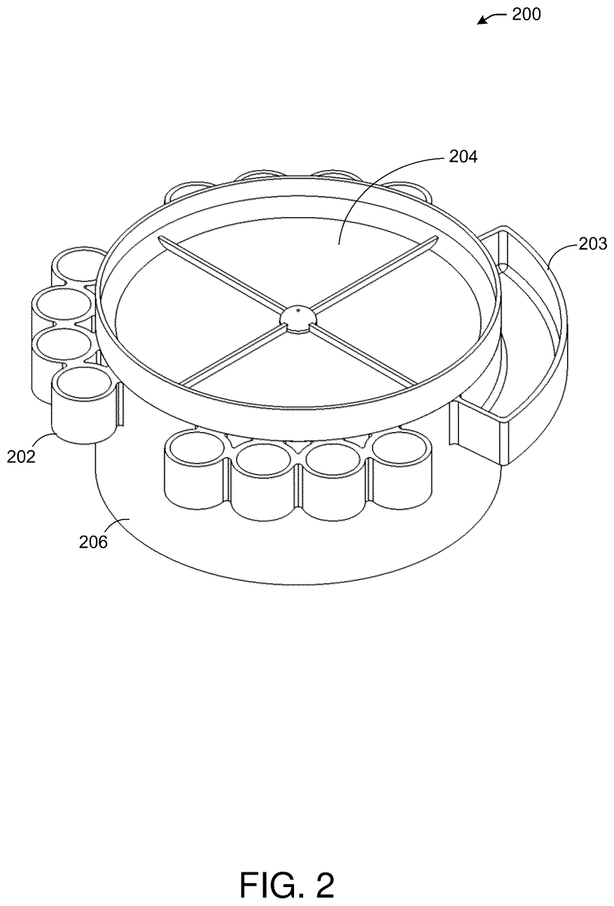

FIG. 2 depicts an engine component cover 200, in accordance with one or more example embodiments of the present disclosure.

In one or more embodiments, the engine component cover 200 may include not only the aforementioned rings, but also an array of thoughtfully designed accessory compartments situated adjacent to the rings. These additional compartments offer extra space to organize and securely store smaller items, such as bolts, nuts, washers, or specialty fasteners that are frequently used during engine maintenance. By strategically positioning these compartments near the rings, the design ensures that users have immediate access to vital components without crowding the workspace or risking the loss of small parts within the engine bay.

As shown in FIG. 2, the top 204, rings 202, and accessory compartment 203 can be secured to surface 206 either as a single mold or as attachments. The compartments, including rings and accessory compartment, may be circular, curved, square, or other shapes for greater versatility and organization. Certain compartments are sized to self-center various spark plug types, improving organization and reducing part loss. These shapes may cover part or all of the engine component cover's side or exterior wall. Certain compartments as designated to be rings, may be hollow or may have a flat surface, as shown in the accessory compartment 203.

Accessory compartment 203 is engineered to address the common challenges faced during engine maintenance, namely, the organization and secure storage of small, easily misplaced components. This accessory compartment 203 is purposefully positioned adjacent to rings 202 on the engine component cover 200, allowing for seamless workflow as users transition between tools and hardware.

In certain embodiments, accessory compartment 203 may be equipped with a shallow depth and gently sloped sides, allowing components to be easily scooped or picked out even while wearing gloves. Accessory compartment 203 could also integrate magnetic or textured bases, reducing the risk of fasteners shifting or rattling loose during movement of engine component cover 200. For environments where static electricity or vibration is a concern, anti-slip lining could be included within accessory compartment 203 to ensure stability of contents.

To further enhance usability, accessory compartment 203 might incorporate transparent or color-coded lids that snap securely into place, providing both visual inventory at a glance and protection from accidental spills. Such a lid for accessory compartment 203 could be hinged or fully removable, adapting to the user's working style.

Ultimately, accessory compartment 203 transforms engine component cover 200 from a simple protective accessory into a multifunctional organizer. By keeping essential small parts within immediate reach, without crowding the main workspace, accessory compartment 203 minimizes downtime, reduces frustration, and helps ensure that no critical hardware is lost during complex repairs. This level of thoughtful integration makes engine component cover 200, complete with accessory compartment 203 and rings 202, an invaluable addition for both professional mechanics and automotive enthusiasts alike.

This arrangement not only enhances efficiency but also streamlines the overall workflow. Mechanics and technicians can quickly sort, retrieve, and return various fasteners, minimizing downtime and reducing the likelihood of misplaced hardware. The thoughtful integration of both rings and adjacent compartments provides a comprehensive solution for organizing a diverse range of tools and parts, further distinguishing the cover as an indispensable asset for both professional and home garages alike.

In one or more embodiments, the engine component cover 200 may be manufactured using a durable, heat-resistant material to ensure reliable performance in the engine bay environment. For example, the cover may be constructed from reinforced plastic or metal alloys that can withstand high temperatures and resist corrosion, providing effective and long-lasting protection for the components it houses.

In one or more embodiments, the accessory compartments can be made with specific dimensions and shapes to closely fit standard hardware sizes used in automotive repair. For example, a compartment may be designed to securely hold carburetor jets, M6 or M8 bolts, or to accommodate washers of a specific diameter, ensuring that these common parts are easily stored and retrieved without risk of misplacement.

In one or more embodiments, the rings may feature flexible inserts or adjustable sizing to hold various spark plug models securely. For example, the ring could include a removable rubber liner that grips different spark plug diameters, allowing technicians to use the cover with a range of engine types and spark plug specifications without needing to swap out components.

The peripheral “rings” referenced throughout this disclosure may take on a variety of forms and nomenclature, serving as multifunctional organizational elements tailored to the needs of engine maintenance. Depending on the particular embodiment, these structures can function as compartments, retainer loops, tool holsters, socket cradles, or organizer slots, among others. Whether circular, curved, or square, each design is intended to securely hold spark plugs, tools, fasteners, or other essential components, while maximizing accessibility and efficiency in the workspace. This flexibility in terminology and form highlights the cover's adaptability, allowing users and designers to select or redefine the compartment style best suited to their specific workflow or application.

The “rings” described here are multifunctional organizational features that can take various forms, such as compartments, retainer loops, tool holsters, socket cradles, or organizer slots. Their adaptable design means users can select whichever style best fits their specific maintenance needs.

It is understood that the above descriptions are for the purposes of illustration and are not meant to be limiting.

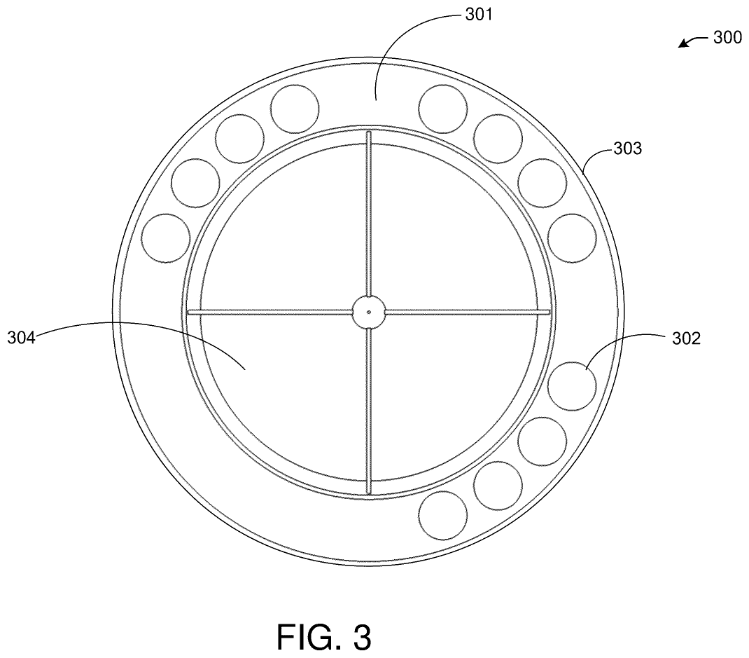

FIG. 3 depicts a top view of an engine component cover 300, in accordance with one or more example embodiments of the present disclosure.

In certain embodiments, the engine component cover 300 features a circumference compartment 301 encircling its central portion comprising the top surface 304. This compartment includes multiple cutouts 302, comparable to rings 202 in FIG. 2, designed to hold spark plugs and/or tools. In addition, the circumference compartment 301 may have a raised outer lip 303 that allows smaller bolts, nuts or other parts to be held in. There may be also dividers (not shown in the Figure) that divide the cutouts 302 in order to create flexible compartments within the circumference compartment 301.

In one or more embodiments, the circumference compartment 301 can be configured so that each cutout 302 is sized to securely hold spark plugs during engine maintenance. For example, a user may place a number of spark plugs into the cutouts 302, keeping them organized and preventing them from rolling away or mixing with other components.

In one or more embodiments, the raised outer lip 303 serves to retain small hardware items such as bolts, nuts, or washers. For example, when a mechanic removes various fasteners during disassembly, these parts can be placed within the circumference compartment 301, where the raised lip ensures they remain in place even if the cover is handled or moved.

In one or more embodiments, removable or adjustable dividers may be included within the circumference compartment 301 to create flexible storage spaces. For example, a technician can reconfigure the dividers to create separate sections for different sizes or types of fasteners or remove them entirely to accommodate longer tools or specialty items. This feature allows the engine component cover to adapt to various workspace needs during different maintenance tasks.

It is understood that the above descriptions are for the purposes of illustration and are not meant to be limiting.

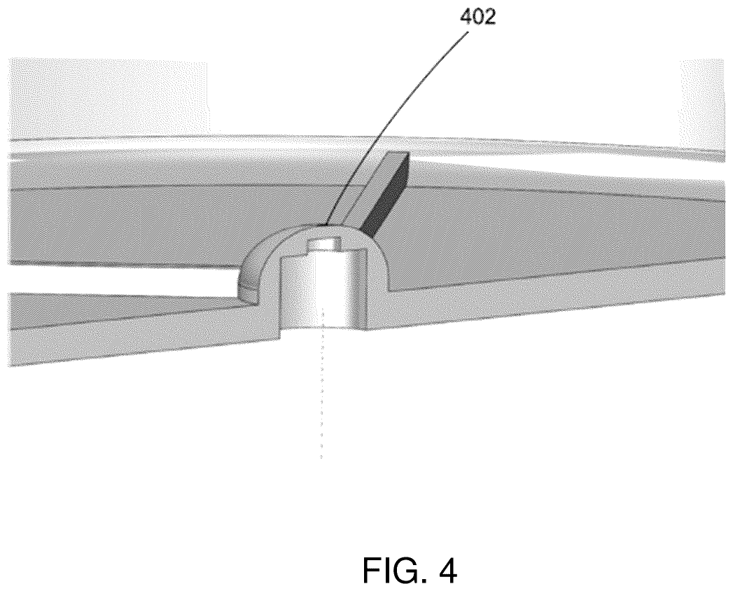

FIG. 4 depicts a perspective view of the engine component cover, in accordance with one or more example embodiments of the present disclosure.

Referring to FIG. 4, the center element 402 of the carburetor cap is a multifunctional element deliberately designed to cater to different securing mechanisms for the air cleaner, allowing the use of either a conventional bolt or a more permanent stud. This flexibility mirrors the universal base of a camera tripod, which can accommodate both a quick-release plate or a threaded mount, depending on preference.

In scenarios where a stud is already in place, the center element 402 exhibits an intelligent break-away design with predetermined thin walls acting as stress points. Their purpose is to break cleanly and effortlessly around a ¼″ stud, reminiscent of the way perforations on a sheet of postage stamps allow for easy separation. This feature precludes the need for any additional tools in the installation process and ensures a secure fit around the stud, similar to how a knockout on an electrical box provides a clean opening for conduit. In the context of engine components and the previously described carburetor cap, a “stud” refers to a cylindrical metal rod or shaft, typically threaded at both ends. In automotive engineering, studs are used as fastening devices that provide a secure and stable means of connecting various components together.

Additionally, for those situations that might call for a larger clearance or a custom fit, the center element 402 includes a center pilot hole. This is a thoughtful inclusion that permits the end-user to drill out the center element 402 to any size required, which could be likened to having a template for a circular cut-out on a speaker installation kit, ensuring versatility for various air cleaner stud diameters.

This center element 402, with its dual functionality and built-in modification potential, showcases a design that is both user-friendly and adaptable, reflecting an acknowledgment of the variety of vehicle specifications and a mechanic's preferences. It upholds the essence of tailored engineering, offering a standard solution for the common ¼″ stud size while also providing the capacity for customization to meet individual requirements of diverse automotive configurations.

It is understood that the above descriptions are for the purposes of illustration and are not meant to be limiting.

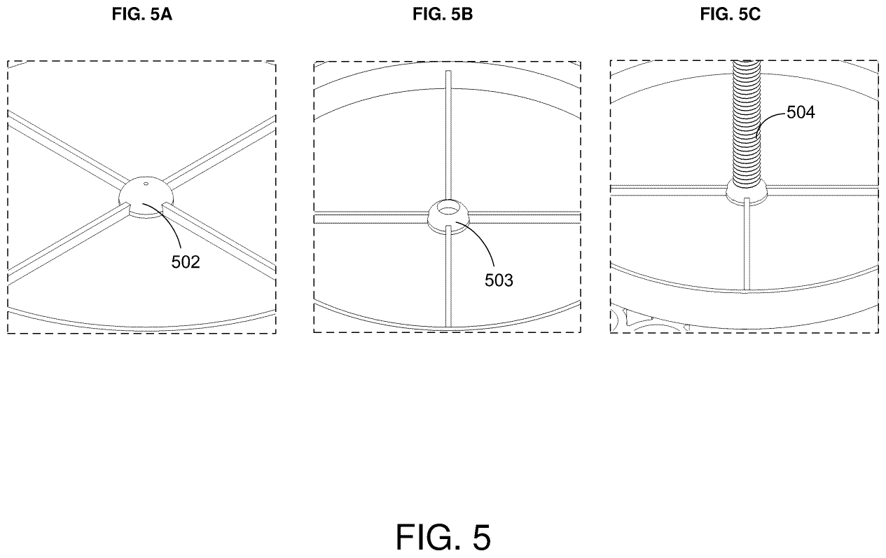

FIGS. 5A-5C depict illustrative schematic diagrams an engine component cover, in accordance with one or more example embodiments of the present disclosure.

Referring to FIG. 5A, there is shown the center element 402 intact before a break away process. Referring to FIG. 5B, there is shown the remaining portion of the center element 402 of FIG. 4 after the break-away process, that functions like the protective rim found on some automotive oil funnels, where it serves to prevent spills. In the case of the carburetor cap, the lip 503 after breaking away for a stud creates a safeguard that circumspectly prevents any objects left on the cap from falling through when the carburetor cap is detached. Much like how a valve cover gasket ensures a tight seal to prevent oil leaks in an engine, the lip 503 fits securely around the stud, effectively preventing anything placed on top of the carburetor cap from falling through the opening and into the delicate components of the carburetor beneath.

This lip 503 acts as an accidental drop guard, analogous to the way raised edges on a car's sunroof prevent objects from sliding off the roof during maintenance, or like the protective barriers around the edges of a utility bed in a pickup truck, effectively preventing tools from sliding off.

Thus, when maintenance requires the cap to be removed, say, for a momentary visual inspection or for the swift adjustment of something beneath it, the lip 503, acting on the same principle as the raised lip on a mechanic's tool tray, keeps any remaining contents safely contained. This design ensures that even in the hasty and often chaotic environment of automotive repairs, the likelihood of foreign objects compromising the engine's carburetor is significantly minimized.

Referring now to FIG. 5C, the illustration demonstrates a stud being inserted cleanly through the lip 503 after the break-away process. This configuration highlights the engineered compatibility of the design: the stud 504 slides through the precisely sized opening, with the lip 503 providing a well-defined boundary that prevents unintended lateral movement or looseness. Much like a bushing or grommet used in machinery to guide and protect moving parts, the lip acts as a stabilizing collar, maintaining alignment and ensuring the cap stays properly seated during engine operation. This feature not only supports a secure installation but also underscores the dual benefit of both protection and adaptability inherent in the assembly's thoughtful construction.

This center element 502 may accommodate a 5/16″ stud (e.g., stud 504) by default but is designed with intelligent breakaway features to also fit ¼″ studs (e.g., stud 504) or be optionally drilled to larger sizes should the user require. This ensures the carburetor, or any engine opening it covers, remains shielded from accidental debris, even during installation or removal, because the element, in one or more embodiments, effectively blocks the entry of foreign objects, regardless of the stud configuration in use.

It should be noted that while the illustrative figures and descriptions refer to a breakaway dome feature, certain embodiments of the engine component cover are manufactured with a pre-formed stud opening. In these versions, the cover arrives ready to fit over the desired stud size without requiring any break-off or modification by the user. This design choice streamlines installation, making the cover immediately compatible with a variety of standard configurations, and is particularly advantageous for users seeking a quick, tool-free setup. By offering both breakaway and pre-formed openings, the design accommodates different preferences and installation contexts, further demonstrating the versatility and user-centric approach of the engine component cover.

The current manufacturing method for the item employs a two-part 3D printing process, which allows for rapid prototyping and design flexibility. This is akin to using a custom hand-built process for creating concept cars before they enter mass production. However, there is a preference to transition to injection mold manufacturing, much like the automotive industry standardizes parts production for high volume, cost-effective distribution.

Injection molding may be used due to its efficiency and ability to produce parts at a higher scale, similar to how car manufacturers produce plastic components for vehicle interiors. This switch would allow for not only a significant uptick in production volumes, akin to the mass production of engine components, but also a typically higher consistency in part quality, comparable to the precision achieved in the standardized production of tires.

It is understood that the above descriptions are for the purposes of illustration and are not meant to be limiting.

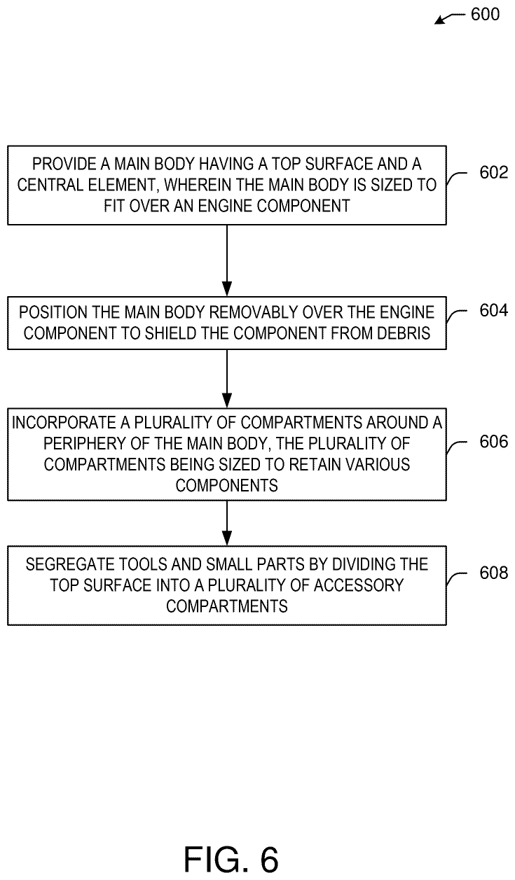

FIG. 6 illustrates a flow of illustrative process 600 for an engine component cover system, in accordance with one or more example embodiments of the present disclosure.

At block 602, a device may provide a main body having a top surface and a central element, wherein the main body is sized to fit over an engine component.

At block 604, the device may position the main body removably over the engine component to shield the component from debris.

At block 606, the device may incorporate a plurality of compartments around a periphery of the main body, the plurality of compartments being sized to retain various components.

At block 608, the device may segregate tools and small parts by dividing the top surface into a plurality of accessory compartments.

In one or more embodiments, a device or a system may include a main body that is designed to be removably installed over an engine component, thereby shielding it from debris and environmental contaminants. For instance, a mechanic may place the device over a carburetor to prevent screws or dirt from falling inside during maintenance. The top surface of the main body may be structured as a tray and divided into multiple accessory compartments, facilitating the segregation and organization of tools and small parts. This solution addresses the common problem of misplaced fasteners and tools during engine repair by providing dedicated spaces for each component.

In these embodiments, a plurality of compartments may be configured around the periphery of the main body, and these compartments may be attached to an outer cylindrical surface either through integral molding or by being separately affixed. For example, the device may feature snap-on side containers for spark plugs and screwdrivers. Each ring of the plurality may include a flexible insert so that spark plugs of varying diameters can be safely accommodated, enhancing the device's versatility for different engine types.

Additionally, at least one accessory compartment may be provided with a magnetic base, which may securely retain metallic fasteners such as bolts, nuts, and washers. This arrangement solves the issue of loose hardware rolling away in confined engine bays. The central element of the device may include predetermined breakaway regions, allowing for tool-free modification to fit securing studs of different sizes. In one or more cases, the diameter of the main body may be selected from a set including 5 inches, 2⅝ inches, 5⅛ inches, or 7 5/16 inches, thereby offering compatibility with a wide range of engine components. For example, a user may quickly adjust the central aperture without tools to fit a specific stud, simplifying installation in the field.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An engine component cover comprising:
a main body having a top surface, the main body configured to be removably installed over an engine component to shield the component from debris;
a plurality of compartments arranged around a periphery of the main body, wherein the plurality of compartments are dimensioned to retain various components;
incorporating at least one accessory compartment for organizing and storing small components including bolts, nuts, and washers; and
integrating a central element on the top surface of the main body, the central element is for receiving a securing stud and being modifiable to accommodate studs of varying diameters.

2. The device of claim 1, wherein the various components comprise spark plugs, bolts, screwdrivers, or other tools and hardware.

3. The engine component cover of claim 1, wherein the top surface is configured as a tray that is divided into a plurality of accessory compartments for segregating tools and parts.

4. The engine component cover of claim 1, wherein the plurality of compartments are attached to an outer cylindrical surface of the main body and are constructed to be integrally molded or separately attached.

5. The engine component cover of claim 1, wherein each ring of the plurality of compartments is provided with a flexible insert configured to accommodate spark plugs of different diameters.

6. The engine component cover of claim 1, wherein the at least one accessory compartment includes a magnetic base for retaining metallic fasteners.

7. The engine component cover of claim 1, wherein the central element is defined to include predetermined breakaway regions for tool-free modification to fit securing studs.

8. The engine component cover of claim 1, wherein the top surface further comprises a detachable LED lighting assembly.

9. The engine component cover of claim 1, wherein the diameter of the main body is selected from at least one of 5 inches, 2⅝ inches, 5⅛ inches, or 7 5/16 inches.

10. The engine component cover of claim 1, wherein the main body is structured to be sufficiently compact to allow closure of a vehicle hood with the apparatus installed on the engine component.

11. A system for protecting and organizing engine components, comprising:
a main body having a top surface, configured to be removably installed over an engine component to shield the component from debris;
a plurality of compartments disposed around a periphery of the main body, sized to retain various components;
at least one accessory compartment integrated within the main body, adapted for organizing and storing small components including bolts, nuts, and washers; and
a central element positioned on the top surface of the main body, the central element including an aperture for receiving a securing stud and configured to be modified for studs of varying diameters.

12. The device of claim 11, wherein the various components comprise spark plugs, bolts, screwdrivers, or other tools and hardware.

13. The system of claim 12, wherein the top surface is structured as a tray divided into multiple accessory compartments for segregating tools and parts.

14. The system of claim 11, wherein the plurality of compartments are attached to an outer cylindrical surface of the main body and are either integrally molded or separately affixed.

15. The system of claim 11, wherein each ring of the plurality includes a flexible insert to accommodate spark plugs of different diameters.

16. The system of claim 11, wherein the at least one accessory compartment is provided with a magnetic base for retaining metallic fasteners.

17. The system of claim 11, wherein the central element includes predetermined breakaway regions for tool-free modification to fit securing studs.

18. The system of claim 11, wherein the diameter of the main body is selected from at least one of 5 inches, 2⅝ inches, 5⅛ inches, or 7 5/16 inches.

19. A method for protecting and organizing engine components, comprising:
providing a main body having a top surface and a central element, wherein the main body is sized to fit over an engine component;
positioning the main body removably over the engine component to shield the component from debris;
incorporating a plurality of compartments around a periphery of the main body, the plurality of compartments being sized to retain various components; and
segregating tools and small parts by dividing the top surface into a plurality of accessory compartments.

20. The method of claim 19, wherein a diameter of the main body is selected from at least one of 5 inches, 2⅝ inches, 5⅛ inches, or 7 5/16 inches.
